(19) United States
(12) Patent Application Publication
(10) Pub. No.: US 2023/0271987 A1
(43) Pub. Date: Aug. 31, 2023

(54) ORGANOMETALLIC PRECURSORS AND RELATED METHODS

(71) Applicant: ENTEGRIS, INC., Billerica, MA (US)

(72) Inventors: Thomas M. Cameron, Newtown, CT (US); David Kuiper, Brookfield, CT (US); David M. Ermert, Danbury, CT (US); Thomas Coyne, Stormville, NY (US)

(21) Appl. No.: 18/107,855

(22) Filed: Feb. 9, 2023

Related U.S. Application Data
(60) Provisional application No. 63/309,181, filed on Feb. 11, 2022.

(51) Int. Cl. C07F 11/00

(52) U.S. Cl. CPC C07F 11/00

(57) ABSTRACT

Some embodiments relate to precursors (including intermediate precursors) and related methods. To prepare an intermediate precursor, a mixture of bis (arene) metal complexes is combined with a first arene. The mixture of bis (arene) metal complexes and the first arene are heated and subsequently cooled. Upon cooling, a bis (first arene) metal complex precipitates from solution to obtain an intermediate precursor with high purity. To prepare a precursor, the bis (first arene) metal complex is contacted with a second arene and heated to obtain a precursor with high purity.

### PRIORITY

The present disclosure claims priority to U.S. provisional patent No. 63/309,181 with a filing date of Feb. 11, 2022 which is incorporated by reference herein.

### FIELD

The present disclosure relates to organometallic precursors for deposition processes, methods for preparing organometallic precursors, and the like.

### BACKGROUND

Metal arene complexes are a class of organometallic compounds useful for a variety of applications. Some applications in which metal arene complexes are useful require highly pure forms of metal arene complexes. However, conventional purification is difficult, expensive, time-consuming, and inefficient.

### SUMMARY

Some embodiments relate to method for preparing an intermediate precursor. In some embodiments, the method for preparing an intermediate precursor comprises, consists of, or consists essentially of one or more of the following steps: combining a mixture of bis (arene) metal complexes and a first arene; heating the mixture of bis (arene) metal complexes and the first arene; and cooling the mixture of bis (arene) metal complexes and the first arene to precipitate a bis (first arene) metal complex.

In some embodiments, a boiling point of the arenes of the bis (arene) metal complexes is greater than a boiling point of the first arene.

In some embodiments, each of the bis (arene) metal complexes present in the mixture of bis (arene) metal complexes is independently a bis (arene) metal complex of the formula:

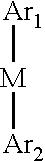

where:
M is a Cr, Mo, W, Fe, or V;
Ar₁ is an arene of the formula:

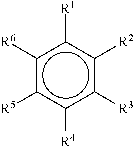

where:
R¹, R², R³, R⁴, R⁵, and R⁶ are each independently a hydrogen, a halogen, a dialkylamino, an alkyl, an alkoxy, an aryl, or a cycloalkyl;
Ar₂ is an arene of the formula:

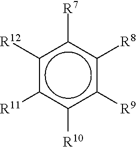

where:
R⁷, R⁸, R⁹, R¹⁰, R¹¹, and R¹² are each independently a hydrogen, a halogen, a dialkylamino, an alkyl, an alkoxy, an aryl, or a cycloalkyl.

In some embodiments, the first arene is an arene of the formula:

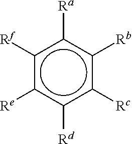

where:
R^{a}, R^{b}, R^{c}, R^{d}, R^{e}, and R^{f} are each independently a hydrogen, a halogen, a dialkylamino, an alkyl, an alkoxy, an aryl, or a cycloalkyl.

In some embodiments, the heating comprises heating to a temperature of 100° C. to 200° C.

In some embodiments, the heating comprises heating at a pressure in a range of atmospheric pressure to 100 bar.

In some embodiments, the cooling comprises exposing to ambient conditions.

In some embodiments, the bis (first arene) metal complex is a complex of the formula:

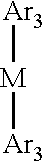

where:
M is Cr, Mo, W, Fe, or V;
Ar₃ is an arene of the formula:

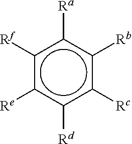

where:
R^{a}, R^{b}, R^{c}, R^{d}, R^{e}, and R^{f} are each independently a hydrogen, a halogen, a dialkylamino, an alkyl, an alkoxy, an aryl, or a cycloalkyl.

In some embodiments, the mixture of bis (arene) metal complexes comprises at least one of benzene ethylbenzene molybdenum, benzene diethylbenzene molybdenum, ethylbenzene diethylbenzene molybdenum (EBDEBMo), bis (ethylbenzene) molybdenum (BEBMo), bis (diethylbenzene) molybdenum (BDEBMo), or any combination thereof.

In some embodiments, the first arene comprises at least one of benzene, toluene, xylene, bibenzyl, diphenylmethane, or any combination thereof.

In some embodiments, the bis (first arene) metal complex is obtained at a yield of 50% or greater.

In some embodiments, the method further comprises separating the bis (first arene) metal complex by filtration to obtain a purified bis (first arene) metal complex having a purity of 90% or greater.

Some embodiments relate to a method for preparing a precursor. In some embodiments, the method for preparing a precursor comprises, consists of, or consists essentially of one or more of the following steps: combining a first arene and a mixture of bis (arene) metal complexes; heating the first arene and the mixture of bis (arene) metal complexes; cooling the first arene and the mixture of bis (arene) metal complexes to obtain a bis (first arene) metal complex; combining the bis (first arene) metal complex and a second arene; and heating the bis (first arene) metal complex and the second arene to obtain a bis (second arene) metal complex.

In some embodiments, a boiling point of the arenes of the bis (arene) metal complexes is greater than a boiling point of the first arene.

In some embodiments, a boiling point of the first arene of the bis (first arene) metal complex is less than a boiling point of the second arene.

In some embodiments, the second arene is an arene having at least one of the following formulas:

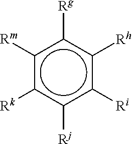

where:
R^{g}, R^{h}, Rⁱ, R^{j}, R^{k}, and R^{m} are each independently a hydrogen, a halogen, a dialkylamino, an alkyl, an alkoxy, an aryl, or a cycloalkyl; or

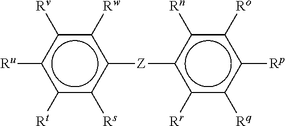

where:
Z is a bond, an alkyl, a heteroatom, or a heteroalkyl; and
Rⁿ, R^{o}, R^{p}, R^{q}, R^{r}, R^{s}, R^{t}, R^{u}, R^{v}, and R^{w} are each independently a hydrogen, a halogen, a dialkylamino, an alkyl, an alkoxy, an aryl, or a cycloalkyl.

In some embodiments, the second arene comprises at least one of benzene, toluene, o-xylene, m-xylene, p-xylene, o-t-butyltoluene, m-t-butyltoluene, p-t-butyltoluene, 1-ethyl-4-methylbenzene, 1-ethyl-3-methylbenzene, 1-isopropyl-4-methylbenzene, 1-t-butyl-4-methylbenzene, mesitylene, pseudocumene, durene, methylbenzene, dimethylbenzene, trimethylbenzene, ethylbenzene, 1,4-diethylbenzene, triethylbenzene, propylbenzene, butylbenzene, iso-butylbenzene, sec-butylbenzene, t-butylbenzene, hexylbenzene, styrene, naphthalene, anthracene, phenanthrene, biphenyl, terphenyl, methylnaphthalene, biphenylene, dimethylnaphthalene, methylanthracene, 4,4′-dimethylbiphenyl, bibenzyl, diphenylmethane, any isomer thereof, or any combination thereof.

In some embodiments, the bis (second arene) metal complex is a complex of at least one of the following formulas:

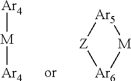

where:
M is Cr, Mo, W, Fe, or V;
Z is a bond, an alkyl, a heteroatom, or a heteroalkyl;
Ar₄ is an arene of the formula:

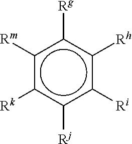

where:
R^{g}, R^{h}, Rⁱ, R^{j}, R^{k}, and R^{m} are each independently a hydrogen, a halogen, a dialkylamino, an alkyl, an alkoxy, an aryl, or a cycloalkyl;
Ar₅ is an arene of the formula:

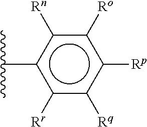

where:
Rⁿ, R^{o}, R^{p}, R^{q}, and R^{r} are each independently a hydrogen, a halogen, a dialkylamino, an alkyl, an alkoxy, an aryl, or a cycloalkyl;
Ar₆ is an arene of the formula:

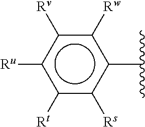

where:
R^{s}, R^{t}, R^{u}, R^{v}, and R^{w} are each independently a hydrogen, a halogen, a dialkylamino, an alkyl, an alkoxy, an aryl, or a cycloalkyl.

Some embodiments relate to a precursor comprising a bis (second arene) metal complex, wherein the bis (second arene) metal complex is a liquid having a purity of at least 90%.

Some embodiments relate to a composition comprising a precursor. In some embodiments, the precursor comprises a bis (arene) metal complex of at least one of the following formulas:

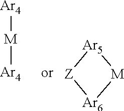

where:
M is Cr, Mo, W, Fe, or V;
Z is a bond, an alkyl, a heteroatom, or a heteroalkyl;
Ar₄ is an arene of the formula:

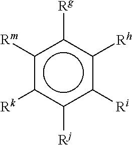

where:
R^{g}, R^{h}, Rⁱ, R^{j}, R^{k}, and R^{m} are each independently a hydrogen, a halogen, a dialkylamino, an alkyl, an alkoxy, an aryl, or a cycloalkyl;
Ar₅ is an arene of the formula:

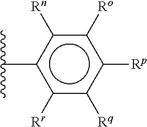

where:
Rⁿ, R^{o}, R^{p}, R^{q}, and R^{r} are each independently a hydrogen, a halogen, a dialkylamino, an alkyl, an alkoxy, an aryl, or a cycloalkyl;
Ar₆ is an arene of the formula:

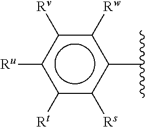

where:
R^{s}, R^{t}, R^{u}, R^{v}, and R^{w} are each independently a hydrogen, a halogen, a dialkylamino, an alkyl, an alkoxy, an aryl, or a cycloalkyl;
wherein the precursor has a purity of 90% or greater.

In some embodiments, the precursor is a liquid having a purity of 99% or greater.

### DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 depicts a non-limiting embodiment of a method for preparing a precursor (including an intermediate precursor), according to some embodiments.

FIG. 2 depicts a non-limiting embodiment of a reaction scheme for preparing a precursor, according to some embodiments.

FIG. 3 is a ¹H NMR spectrum of isolated bis (benzene) molybdenum, according to some embodiments.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “alkyl” refers to a hydrocarbon compound having from 1 to 30 carbon atoms. An alkyl having n carbon atoms may be designated as a “Cₙ alkyl.” For example, a “C₃ alkyl” may include n-propyl and isopropyl. An alkyl having a range of carbon atoms, such as 1 to 30 carbon atoms, may be designated as a C₁-C₃₉ alkyl. In some embodiments, the alkyl is linear. In some embodiments, the alkyl is branched. In some embodiments, the alkyl is substituted. In some embodiments, the alkyl is unsubstituted. In some embodiments, the alkyl comprises or is selected from the group consisting of at least one of a C₁-C₁₀ alkyl, a C₁-C₉ alkyl, a C₁-C₈ alkyl, a C₁-C₇ alkyl, a C₁-C₆ alkyl, a C₁-C₅ alkyl, a C₁-C₄ alkyl, a C₁-C₃ alkyl, a C₂-C₁₀ alkyl, a C₃-C₁₀ alkyl, a C₄-C₁₀ alkyl, a C₅-C₁₀ alkyl, a C₆-C₁₀ alkyl, a C₇-C₁₀ alkyl, a C₈-C₁₀ alkyl, a C₂-C₉ alkyl, a C₂-C₈ alkyl, a C₂-C₇ alkyl, a C₂-C₆ alkyl, a C₂-C₅ alkyl, a C₃-C₅ alkyl, or any combination thereof. In some embodiments, the alkyl comprises or is selected from the group consisting of at least one of methyl, ethyl, n-propyl, 1-methylethyl (iso-propyl), n-butyl, iso-butyl, sec-butyl, n-pentyl, 1,1-dimethylethyl (t-butyl), n-pentyl, iso-pentyl, n-hexyl, isohexyl, 3-methylhexyl, 2-methylhexyl, heptyl, octyl, nonyl, decyl, dodecyl, octadecyl, or any combination thereof.

As used herein, the term “arene” refers to a monocyclic or polycyclic aromatic hydrocarbon compound. The number of carbon atoms of the arene may be in a range of 5 carbon atoms to 100 carbon atoms. In some embodiments, the arene has 5 to 20 carbon atoms. For example, in some embodiments, the arene has 6 to 8 carbon atoms, 6 to 10 carbon atoms, 6 to 12 carbon atoms, 6 to 15 carbon atoms, or 6 to 20 carbon atoms. The term “monocyclic,” when used as a modifier, refers to an arene having a single aromatic ring structure. The term “polycyclic,” when used as a modifier, refers to an arene having more than one aromatic ring structure, which may be fused, bridged, spiro, or otherwise bonded ring structures. The term “alkyl-substituted arene” refers to an arene comprising one or more alkyl substituents. In some embodiments, the alkyl-substituted arene may comprise at least one of a monoalkylbenzene, a dialkylbenzene, a trialkylbenzene, a tetralkylbenzene, or any combination thereof. An arene may be referred to herein as Ar.

Non-limiting examples of arenes include, without limitation, at least one of benzene, toluene, xylene (e.g., o-xylene, m-xylene, p-xylene), t-butyltoluene (e.g., o-t-butyltoluene, m-t-butyltoluene, p-t-butyltoluene), ethylmethylbenzene (e.g., 1-ethyl-4-methylbenzene, 1-ethyl-3-methylbenzene), 1-isopropyl-4-methylbenzene, 1-t-butyl-4-methylbenzene, mesitylene, pseudocumene, durene, methylbenzene, dimethylbenzene, trimethylbenzene, ethylbenzene, diethylbenzene (e.g., 1,4-diethylbenzene), triethylbenzene, propylbenzene, butylbenzene, iso-butylbenzene, sec-butylbenzene, t-butylbenzene, hexylbenzene, styrene, naphthalene, anthracene, phenanthrene, biphenyl, terphenyl, methylnaphthalene, biphenylene, dimethylnaphthalene, methylanthracene, 4,4′-dimethylbiphenyl, bibenzyl, diphenylmethane, any isomer thereof, or any combination thereof, and the like.

As used herein, the term “metal” refers to at least one of an alkali metal, an alkaline earth metal, a transition metal, a post-transition metal, a lanthanoid, or any combination thereof. In some embodiments, for example, the metal comprises or is selected from the group consisting of a transition metal. In some embodiments, the metal comprises or is selected from the group consisting of a Group VIB metal. In some embodiments, the metal comprises or is selected from the group consisting of at least one of chromium (Cr), molybdenum (Mo), tungsten (W), or any combination thereof. In some embodiments, the metal comprises or is selected from the group consisting of at least one of chromium (Cr), molybdenum (Mo), tungsten (W), iron (Fe), vanadium (V), or any combination thereof. In some embodiments, the metal is in ionic form, elemental form, or any combination thereof.

As used herein, the term “bis (arene) metal complex” refers to any organometallic compound comprising at least two arenes bound (e.g., coordinated) to a metal. Each of the arenes may independently be substituted or unsubstituted. In some embodiments, a bis (arene) metal complex comprises only one substituted arene coordinated to a metal. For example, in some embodiments, the bis (arene) metal complex comprises benzene ethylbenzene molybdenum, where ethylbenzene is the substituted arene. In some embodiments, a bis (arene) metal complex comprises two substituted arenes coordinated to a metal. For example, in some embodiments, the bis (arene) metal complex comprises bis (diethylbenzene) molybdenum, where both diethylbenzenes are substituted arenes. In some embodiments, a bis (arene) metal complex comprises two arenes coordinated to a metal, wherein the two arenes are the same and wherein the two arenes may be substituted or unsubstituted.

Non-limiting examples of bis (arene) metal complexes include, without limitation, at least one of bis (benzene) molybdenum, bis (benzene) tungsten, bis (toluene) molybdenum, bis (toluene) tungsten, bis (xylene) molybdenum, bis (xylene) tungsten, bis (ethylbenzene) molybdenum, bis (ethylbenzene) tungsten, bis (benzene) chromium, bis (ethylbenzene) chromium, bis (toluene) chromium, bis (mesitylene) chromium, bis (mesitylene) molybdenum, bis (tetralin) chromium, bis (diphenyl) chromium, bis (diphenyl) molybdenum, bis (mesitylene) molybdenum, bis (mesitylene) tungsten, bis (benzene) iron, bis (toluene) iron, bis (xylene) chromium, bis (xylene) iron, bis-(mesitylene) iron, bis (durene) iron, bis (hexamethylbenzene) iron, bis (hexamethylbenzene) chromium, bis (benzene) vanadium, bis (toluene)vanadium, any bis (arene isomer) metal complex thereof, or any combination thereof.

As used herein, the term “based on” is not exclusive and allows for being based on additional factors not described herein, unless the context clearly dictates otherwise. In addition, throughout the specification, the meaning of “a,” “an,” and “the” include plural references. The meaning of “in” includes “in” and “on.”

Some organometallic precursors useful for semiconductor fabrication processes require high purity. However, it can be difficult to obtain organometallic compounds with the requisite high purity, as methods for synthesizing bis (arene) metal complexes exhibit significant variation from batch to batch, both in terms of the reaction products and the amounts of each reaction product, among other things. In addition, due to alkyl and dialkyl rearrangement, Fischer-Hafner synthesis of bis (ethyl benzene) molybdenum results in a mixture of isomers of bis (ethylbenzene) molybdenum and of bis (diethylbenzene) molybdenum. Approaches for isolating specific bis (arene) metal complexes from mixtures of bis (arene) metal complexes are either not available or are difficult, expensive, time-consuming, and inefficient.

Some embodiments relate to methods for preparing intermediate precursors and precursors that overcome at least some of the above-mentioned challenges. As described herein, it has been discovered that mixtures of bis (arene) metal complexes may be contacted with a first arene that is less electron donating and/or has a lower boiling point than the arenes of the bis (arene) metal complexes to obtain a bis (first arene) metal complex as an intermediate precursor with high purity. The limited solubility of the bis (first arene) metal complex unexpectedly allows for isolation of the bis (first arene) metal complex in the presence of the higher boiling point, more electron donating arenes of the bis (arene) metal complexes. The bis (first arene) metal complex may subsequently be contacted with a second arene to obtain a bis (second arene) metal complex as a precursor with high purity.

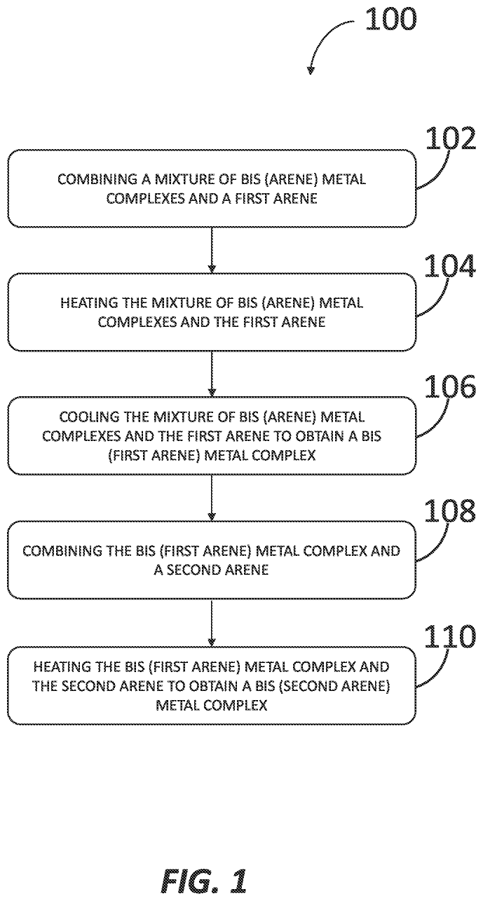

FIG. 1 depicts a non-limiting embodiment of a method 100 for preparing a precursor (including an intermediate precursor), according to some embodiments.

As shown in FIG. 1, in some embodiments, the method 100 comprises, consists of, or consists essentially of one or more of the following steps: a step 102 of combining a mixture of bis (arene) metal complexes and a first arene; a step 104 of heating the mixture of bis (arene) metal complexes and the first arene; a step 106 of cooling the mixture of bis (arene) metal complexes and the first arene to obtain a bis (first arene) metal complex; a step 108 of combining the bis (first arene) metal complex and the second arene; and a step 110 of heating the bis (first arene) metal complex and the second arene to obtain a bis (second arene) metal complex.

In some embodiments, the method 100 is a method for preparing an intermediate precursor. In some embodiments, the method for preparing an intermediate precursor comprises, consists of, or consists essentially of one or more of step 102, step 104, and step 106. In some embodiments, the method 100 is a method for preparing a precursor. In some embodiments, the method for preparing a precursor comprises, consists of, or consists essentially of one or more of step 108 and step 110. In some embodiments, the method for preparing a precursor comprises, consists of, or consists essentially of one or more of step 102, step 104, step 106, step 108, and step 110.

At step 102, in some embodiments, a mixture of bis (arene) metal complexes is combined with a first arene.

The manner in which the mixture of bis (arene) metal complexes is combined with the first arene is not particularly limited. In some embodiments, the combining comprises contacting the mixture of bis (arene) metal complexes and the first arene. In some embodiments, the combining comprises mixing the mixture of bis (arene) metal complexes and the first arene. In some embodiments, the combining comprises feeding the mixture of bis (arene) metal complexes and the first arene, either separately or together, to a reaction vessel. In some embodiments, the combining comprises flowing or pumping the mixture of bis (arene) metal complexes and the first arene, either separately or together, to a reaction vessel. In some embodiments, the combining comprises introducing the mixture of bis (arene) metal complexes and the first arene, either separately or together, to a reaction vessel. In other embodiments, the contacting comprises at least one of pouring, disposing, adding, or any combination thereof the mixture of bis (arene) metal complexes and the first arene to a reaction vessel.

The mixture of bis (arene) metal complexes may comprise one or more bis (arene) metal complexes. In some embodiments, the mixture of bis (arene) metal complexes is a mixture of reaction products. For example, in some embodiments, the mixture of bis (arene) metal complexes is an initial mixture comprising bis (arene) metal complexes produced via at least one of Fischer-Hafner Synthesis (FHS), Friedal Crafts reaction, arene metathesis, or any combination thereof. It will be appreciated that other synthetic routes and reactions may be used herein to obtain the mixture of bis (arene) metal complexes without departing from the scope of the present disclosure.

In some embodiments, the mixture of bis (arene) metal complexes comprises a plurality of different bis (arene) metal complexes. The number of different bis (arene) metal complexes present in the mixture is not particularly limited and may include, for example and without limitation, up to 100 different types of bis (arene) metal complexes. In some embodiments, the difference between the bis (arene) metal complexes is the substituent(s) (or number of substituent(s)) attached to the arene of the bis (arene) metal complexes. In some embodiments, the difference between the bis (arene) metal complexes is the stereochemistry (or spatial arrangement) of the substituent(s) attached to the arenes of the bis (arene) metal complexes. For example, in some embodiments, the mixture of bis (arene) metal complexes comprises at least one plurality of isomers of bis (arene) metal complexes. In some embodiments, the difference between the bis (arene) metal complexes is the metal of the bis (arene) metal complexes. In some embodiments, the difference between the bis (arene) metal complexes is any combination of one or more of the foregoing differences.

In some embodiments, each of the bis (arene) metal complexes present in the mixture of bis (arene) metal complexes is independently a bis (arene) metal complex of the formula:

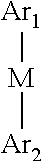

wherein:
M is a metal;
Ar₁ is an arene; and
Ar₂ is an arene, which may be the same as Ar₁ or which may be different from Ar₁.

In some embodiments, Ar₁ is an arene of the formula:

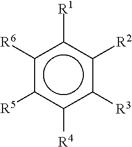

where:
   R¹, R², R³, R⁴, R⁵, and R⁶ are each independently a hydrogen, a halogen, a dialkylamino, an alkyl, an alkoxy, an aryl, or a cycloalkyl.

In some embodiments, Ar₁ is a substituted arene, an unsubstituted arene, or any combination thereof. In some embodiments, for example, Ar₁ comprises at least one of a monoalkylbenzene, a dialkylbenzene, a trialkylbenzene, a tetralkylbenzene, or any combination thereof. In some embodiments, the alkyl comprises or is selected from the group consisting of at least one of a C₁-C₁₀ alkyl, a C₁-C₉ alkyl, a C₁-C₈ alkyl, a C₁-C₇ alkyl, a C₁-C₆ alkyl, a C₁-C₅ alkyl, a C₁-C₄ alkyl, a C₁-C₃ alkyl, a C₂-C₁₀ alkyl, a C₃-C₁₀ alkyl, a C₄-C₁₀ alkyl, a C₅-C₁₀ alkyl, a C₆-C₁₀ alkyl, a C₇-C₁₀ alkyl, a C₈-C₁₀ alkyl, a C₂-C₉ alkyl, a C₂-C₈ alkyl, a C₂-C₇ alkyl, a C₂-C₆ alkyl, a C₂-C₅ alkyl, a C₃-C₅ alkyl, or any combination thereof. In some embodiments, the alkyl comprises or is selected from the group consisting of at least one of methyl, ethyl, n-propyl, 1-methylethyl (iso-propyl), n-butyl, iso-butyl, sec-butyl, n-pentyl, 1,1-dimethylethyl (t-butyl), n-pentyl, iso-pentyl, n-hexyl, isohexyl, 3-methylhexyl, 2-methylhexyl, heptyl, octyl, nonyl, decyl, dodecyl, octadecyl, or any combination thereof.

In some embodiments, for example, Ar₁ comprises or is selected from the group consisting of at least one of benzene, toluene, o-xylene, m-xylene, p-xylene, o-t-butyltoluene, m-t-butyltoluene, p-t-butyltoluene, 1-ethyl-4-methylbenzene, 1-ethyl-3-methylbenzene, 1-isopropyl-4-methylbenzene, 1-t-butyl-4-methylbenzene, mesitylene, pseudocumene, durene, methylbenzene, dimethylbenzene, trimethylbenzene, ethylbenzene, 1,4-diethylbenzene, triethylbenzene, propylbenzene, butylbenzene, iso-butylbenzene, sec-butylbenzene, t-butylbenzene, hexylbenzene, styrene, naphthalene, anthracene, phenanthrene, biphenyl, terphenyl, methylnaphthalene, biphenylene, dimethylnaphthalene, methylanthracene, 4,4′-dimethylbiphenyl, bibenzyl, diphenylmethane, any isomer thereof, or any combination thereof.

In some embodiments, Ar₂ is an arene of the formula:

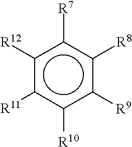

where:
R⁷, R⁸, R⁹, R¹⁰, R¹¹, and R¹² are each independently a hydrogen, a halogen, a dialkylamino, an alkyl, an alkoxy, an aryl, or a cycloalkyl.

In some embodiments, Ar₂ is a substituted arene, an unsubstituted arene, or any combination thereof. In some embodiments, for example, Ar₂ comprises at least one of a monoalkylbenzene, a dialkylbenzene, a trialkylbenzene, a tetralkylbenzene, or any combination thereof. In some embodiments, the alkyl comprises or is selected from the group consisting of at least one of a C₁-C₁₀ alkyl, a C₁-C₉ alkyl, a C₁-C₈ alkyl, a C₁-C₇ alkyl, a C₁-C₆ alkyl, a C₁-C₅ alkyl, a C₁-C₄ alkyl, a C₁-C₃ alkyl, a C₂-C₁₀ alkyl, a C₃-C₁₀ alkyl, a C₄-C₁₀ alkyl, a C₅-C₁₀ alkyl, a C₆-C₁₀ alkyl, a C₇-C₁₀ alkyl, a C₈-C₁₀ alkyl, a C₂-C₉ alkyl, a C₂-C₈ alkyl, a C₂-C₇ alkyl, a C₂-C₆ alkyl, a C₂-C₅ alkyl, a C₃-C₅ alkyl, or any combination thereof. In some embodiments, the alkyl comprises or is selected from the group consisting of at least one of methyl, ethyl, n-propyl, 1-methylethyl (iso-propyl), n-butyl, iso-butyl, sec-butyl, n-pentyl, 1,1-dimethylethyl (t-butyl), n-pentyl, iso-pentyl, n-hexyl, isohexyl, 3-methylhexyl, 2-methylhexyl, heptyl, octyl, nonyl, decyl, dodecyl, octadecyl, or any combination thereof.

In some embodiments, for example, Ar₂ comprises or is selected from the group consisting of at least one of benzene, toluene, o-xylene, m-xylene, p-xylene, o-t-butyltoluene, m-t-butyltoluene, p-t-butyltoluene, 1-ethyl-4-methylbenzene, 1-ethyl-3-methylbenzene, 1-isopropyl-4-methylbenzene, 1-t-butyl-4-methylbenzene, mesitylene, pseudocumene, durene, methylbenzene, dimethylbenzene, trimethylbenzene, ethylbenzene, 1,4-diethylbenzene, triethylbenzene, propylbenzene, butylbenzene, iso-butylbenzene, sec-butylbenzene, t-butylbenzene, hexylbenzene, styrene, naphthalene, anthracene, phenanthrene, biphenyl, terphenyl, methylnaphthalene, biphenylene, dimethylnaphthalene, methylanthracene, 4,4′-dimethylbiphenyl, bibenzyl, diphenylmethane, any isomer thereof, or any combination thereof.

In some embodiments, the mixture of bis (arene) metal complexes comprises at least one bis (arene) metal complex in which Ar₁ and Ar₂ are the same. In some embodiments, the mixture of bis (arene) metal complexes comprises at least one bis (arene) metal complex in which Ar₁ and Ar₂ are different.

In some embodiments, the metal of the bis (arene) metal complexes comprises or is selected from the group consisting of a transition metal. In some embodiments, the metal comprises or is selected from the group consisting of a Group VIB metal. In some embodiments, the metal comprises or is selected from the group consisting of at least one of chromium (Cr), molybdenum (Mo), tungsten (W), or any combination thereof. In some embodiments, the metal comprises or is selected from the group consisting of at least one of chromium (Cr), molybdenum (Mo), tungsten (W), iron (Fe), vanadium (V), or any combination thereof.

The first arene, which may be substituted or unsubstituted, may comprise an arene that is different from the arene(s) of the bis (arene) metal complexes included in the mixture. For example, the first arene may have at least one of different substituent(s), different spatial arrangement of substituent(s), different numbers of substituent(s), or any combination thereof.

The first arene may be chosen based on the arene(s) of the bis (arene) metal complexes included in the mixture. That is, the first arene may be chosen to have a boiling point that is less than at least one (or all) of the arenes of the bis (arene) metal complexes. For example, in some embodiments, a boiling point of the arenes of the bis (arene) metal complexes is greater than a boiling point of the first arene. The first arene may be chosen to have a characteristic of being less electron donating than at least one (or all) of the arenes of the bis (arene) metal complexes. For example, in some embodiments, the arenes of the bis (arene) metal complexes have a greater number of substituents (and thus may be more electron donating) than the first arene. Accordingly, in some embodiments, the first arene is chosen so as to have a lower boiling point, a fewer number of substituents (or otherwise to be less electron donating), or any combination thereof than the arenes of the bis (arene) metal complexes.

In some embodiments, the first arene is an arene of the formula:

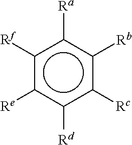

where:
R^{a}, R^{b}, R^{c}, R^{d}, R^{e}, and R^{f} are each independently a hydrogen, a halogen, a dialkylamino, an alkyl, an alkoxy, an aryl, or a cycloalkyl.

In some embodiments, the first arene is a substituted arene, an unsubstituted arene, or any combination thereof. In some embodiments, the first arene is or comprises at least one alkyl-substituted arene. In some embodiments, for example, the first arene comprises at least one of a monoalkylbenzene, a dialkylbenzene, a trialkylbenzene, a tetralkylbenzene, or any combination thereof. In some embodiments, the alkyl comprises or is selected from the group consisting of at least one of a C₁-C₁₀ alkyl, a C₁-C₉ alkyl, a C₁-C₈ alkyl, a C₁-C₇ alkyl, a C₁-C₆ alkyl, a C₁-C₅ alkyl, a C₁-C₄ alkyl, a C₁-C₃ alkyl, a C₂-C₁₀ alkyl, a C₃-C₁₀ alkyl, a C₄-C₁₀ alkyl, a C₅-C₁₀ alkyl, a C₆-C₁₀ alkyl, a C₇-C₁₀ alkyl, a C₈-C₁₀ alkyl, a C₂-C₉ alkyl, a C₂-C₈ alkyl, a C₂-C₇ alkyl, a C₂-C₆ alkyl, a C₂-C₅ alkyl, a C₃-C₅ alkyl, or any combination thereof. In some embodiments, the alkyl comprises or is selected from the group consisting of at least one of methyl, ethyl, n-propyl, 1-methylethyl (iso-propyl), n-butyl, iso-butyl, sec-butyl, n-pentyl, 1,1-dimethylethyl (t-butyl), n-pentyl, iso-pentyl, n-hexyl, isohexyl, 3-methylhexyl, 2-methylhexyl, heptyl, octyl, nonyl, decyl, dodecyl, octadecyl, or any combination thereof.

In some embodiments, for example, the first arene comprises or is selected from the group consisting of at least one of benzene, toluene, o-xylene, m-xylene, p-xylene, o-t-butyltoluene, m-t-butyltoluene, p-t-butyltoluene, 1-ethyl-4-methylbenzene, 1-ethyl-3-methylbenzene, 1-isopropyl-4-methylbenzene, 1-t-butyl-4-methylbenzene, mesitylene, pseudocumene, durene, methylbenzene, dimethylbenzene, trimethylbenzene, ethylbenzene, 1,4-diethylbenzene, triethylbenzene, propylbenzene, butylbenzene, iso-butylbenzene, sec-butylbenzene, t-butylbenzene, hexylbenzene, styrene, naphthalene, anthracene, phenanthrene, biphenyl, terphenyl, methylnaphthalene, biphenylene, dimethylnaphthalene, methylanthracene, 4,4′-dimethylbiphenyl, bibenzyl, diphenylmethane, any isomer thereof, or any combination thereof.

At step 104, in some embodiments, the mixture of bis (arene) metal complexes and the first arene are heated.

The manner in which the mixture of the bis (arene) metal complexes and the first arene are heated is not particularly limited. In some embodiments, the heating comprises heating the mixture of bis (arene) metal complexes and the first arene to a first temperature. In some embodiments, the heating comprises heating the mixture of bis (arene) metal complexes and the first arene at a first temperature. In some embodiments, the heating comprises heating the mixture of bis (arene) metal complexes and the first arene in an oven, in a furnace, on a hot plate, or other heating device and/or apparatus. In some embodiments, the heating comprises immersing the mixture of bis (arene) metal complexes and the first arene in a hot fluid bath (e.g., a hot water bath). In some embodiments, the heating comprises contacting the mixture of bis (arene) metal complexes and the first arene with a fluid (e.g., a gas or a vapor, a liquid, etc.) having the first temperature. In some embodiments, the heating comprises exposing the mixture of bis (arene) metal complexes and the first arene to a fluid (e.g., a gas or a vapor, a liquid, etc.) having the first temperature.

The first temperature may be a temperature below a decomposition temperature (e.g., a thermal decomposition temperature) of at least one of the bis (arene) metal complexes, the first arene, or any combination thereof. The first temperature may be a temperature at or above a threshold temperature (e.g., a minimum reaction temperature). In some embodiments, the first temperature is a temperature in a range of 100° C. to 200° C. For example, in some embodiments, the first temperature is a temperature in a range 110° C. to 200° C., 115° C. to 200° C., 120° C. to 200° C., 125° C. to 200° C., 130° C. to 200° C., 135° C. to 200° C., 140° C. to 200° C., 145° C. to 200° C., 150° C. to 200° C., 155° C. to 200° C., 160° C. to 200° C., 165° C. to 200° C., 170° C. to 200° C., 175° C. to 200° C., 180° C. to 200° C., 185° C. to 200° C., 190° C. to 200° C., 195° C. to 200° C., or any combination thereof. In some embodiments, the first temperature is a temperature in a range of 100° C. to 195° C., 100° C. to 190° C., 100° C. to 185° C., 100° C. to 180° C., 100° C. to 175° C., 100° C. to 170° C., 100° C. to 165° C., 100° C. to 160° C., 100° C. to 155° C., 100° C. to 150° C., 100° C. to 145° C., 100° C. to 140° C., 100° C. to 135° C., 100° C. to 130° C., 100° C. to 125° C., 100° C. to 120° C., 100° C. to 115° C., 100° C. to 110° C., 100° C. to 105° C., or any combination thereof.

In some embodiments, the heating is performed under a vacuum. In some embodiments, the heating is performed under pressure. For example, the heating may be performed at a pressure in a range of atmospheric pressure to 100 bar. In some embodiments, the pressure is in a range of at least one of 1 bar to 100 bar, 10 bar to 100 bar, 20 bar to 100 bar, 30 bar to 100 bar, 40 bar to 100 bar, 50 bar to 100 bar, 60 bar to 100 bar, 70 bar to 100 bar, 80 bar to 100 bar, 90 bar to 100 bar, 1 bar to 90 bar, 1 bar to 80 bar, 1 bar to 70 bar, 1 bar to 60 bar, 1 bar to 50 bar, 1 bar to 40 bar, 1 bar to 30 bar, 1 bar to 20 bar, 1 bar to 10 bar 1 bar to 5 bar, or any combination thereof.

At step 106, in some embodiments, the mixture of bis (arene) metal complexes and the first arene are cooled to obtain a bis (first arene) metal complex.

The manner in which the mixture of the bis (arene) metal complexes and the first arene are cooled is not particularly limited. In some embodiments, the cooling comprises cooling the mixture of bis (arene) metal complexes and the first arene to a second temperature which is below the first temperature. In some embodiments, the cooling comprises exposing the mixture of bis (arene) metal complexes and the first arene to ambient conditions (e.g., temperature, pressure, etc.). In some embodiments, the cooling comprises immersing the mixture of bis (arene) metal complexes and the first arene in a cold fluid bath (e.g., a cold water bath). In some embodiments, the cooling comprises contacting the mixture of bis (arene) metal complexes and the first arene with a fluid (e.g., a gas or a vapor, a liquid, etc.) having the second temperature. In some embodiments, the cooling comprises exposing the mixture of bis (arene) metal complexes and the first arene to a fluid (e.g., a gas or a vapor, a liquid, etc.) having the second temperature.

As mentioned above, the mixture of bis (arene) metal complexes and the first arene are cooled to obtain the bis (first arene) metal complex. That is, upon cooling, a bis (first arene) metal complex may be formed in which the arene(s) of the bis (arene) metal complexes are replaced by the first arene. The bis (first arene) metal complex may crystallize, precipitate (e.g., from solution), or any combination thereof via the cooling. In some embodiments, the bis (first arene) metal complex is obtained as a solid. In some embodiments, the bis (first arene) metal complex is obtained as a liquid. In some embodiments, the bis (first arene) metal complex is obtained (e.g., isolated, recovered, etc.) by filtration. In some embodiments, the bis (first arene) metal complex is obtained by at least one of sublimation, distillation, or any combination thereof.

In some embodiments, the bis (first arene) metal complex comprises a complex of the formula:

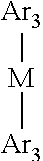

where:
M is a metal; and
Ar₃ is the first arene.

In some embodiments, for example, Ar₃ is an arene of the formula:

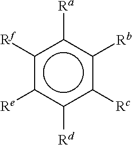

where:
R^{a}, R^{b}, R^{c}, R^{d}, R^{e}, and R^{f} are each independently a hydrogen, a halogen, a dialkylamino, an alkyl, an alkoxy, an aryl, or a cycloalkyl.

In some embodiments, the first arene is a substituted arene, an unsubstituted arene, or any combination thereof. In some embodiments, the first arene is or comprises at least one alkyl-substituted arene. In some embodiments, for example, the first arene comprises at least one of a monoalkylbenzene, a dialkylbenzene, a trialkylbenzene, a tetralkylbenzene, or any combination thereof. In some embodiments, the alkyl comprises or is selected from the group consisting of at least one of a C₁-C₁₀ alkyl, a C₁-C₉ alkyl, a C₁-C₈ alkyl, a C₁-C₇ alkyl, a C₁-C₆ alkyl, a C₁-C₅ alkyl, a C₁-C₄ alkyl, a C₁-C₃ alkyl, a C₂-C₁₀ alkyl, a C₃-C₁₀ alkyl, a C₄-C₁₀ alkyl, a C₅-C₁₀ alkyl, a C₆-C₁₀ alkyl, a C₇-C₁₀ alkyl, a C₈-C₁₀ alkyl, a C₂-C₉ alkyl, a C₂-C₈ alkyl, a C₂-C₇ alkyl, a C₂-C₆ alkyl, a C₂-C₅ alkyl, a C₃-C₅ alkyl, or any combination thereof. In some embodiments, the alkyl comprises or is selected from the group consisting of at least one of methyl, ethyl, n-propyl, 1-methylethyl (iso-propyl), n-butyl, iso-butyl, sec-butyl, n-pentyl, 1,1-dimethylethyl (t-butyl), n-pentyl, iso-pentyl, n-hexyl, isohexyl, 3-methylhexyl, 2-methylhexyl, heptyl, octyl, nonyl, decyl, dodecyl, octadecyl, or any combination thereof.

In some embodiments, for example, the first arene comprises or is selected from the group consisting of at least one of benzene, toluene, o-xylene, m-xylene, p-xylene, o-t-butyltoluene, m-t-butyltoluene, p-t-butyltoluene, 1-ethyl-4-methylbenzene, 1-ethyl-3-methylbenzene, 1-isopropyl-4-methylbenzene, 1-t-butyl-4-methylbenzene, mesitylene, pseudocumene, durene, methylbenzene, dimethylbenzene, trimethylbenzene, ethylbenzene, 1,4-diethylbenzene, triethylbenzene, propylbenzene, butylbenzene, iso-butylbenzene, sec-butylbenzene, t-butylbenzene, hexylbenzene, styrene, naphthalene, anthracene, phenanthrene, biphenyl, terphenyl, methylnaphthalene, biphenylene, dimethylnaphthalene, methylanthracene, 4,4′-dimethylbiphenyl, bibenzyl, diphenylmethane, any isomer thereof, or any combination thereof.

In some embodiments, the metal of the bis (first arene) metal complexes comprises or is selected from the group consisting of a transition metal. In some embodiments, the metal comprises or is selected from the group consisting of a Group VIB metal. In some embodiments, the metal comprises or is selected from the group consisting of at least one of chromium (Cr), molybdenum (Mo), tungsten (W), or any combination thereof. In some embodiments, the metal comprises or is selected from the group consisting of at least one of chromium (Cr), molybdenum (Mo), tungsten (W), iron (Fe), vanadium (V), or any combination thereof.

At step 108, in some embodiments, the bis (first arene) metal complex is combined with a second arene.

The manner in which the bis (first arene) metal complex is combined with the second arene is not particularly limited. In some embodiments, the combining comprises contacting the bis (first arene) metal complex and the second arene. In some embodiments, the combining comprises mixing the bis (first arene) metal complex and the second arene. In some embodiments, the combining comprises feeding the bis (first arene) metal complex and the second arene, either separately or together, to a reaction vessel. In some embodiments, the combining comprises flowing or pumping the bis (first arene) metal complex and the second arene, either separately or together, to a reaction vessel. In some embodiments, the combining comprises introducing the bis (first arene) metal complex and the second arene, either separately or together, to a reaction vessel. In other embodiments, the contacting comprises at least one of pouring, disposing, adding, or any combination thereof the bis (first arene) metal complex and the second arene to a reaction vessel.

The second arene, which may be substituted or unsubstituted, may comprise an arene that is different from the first arene of the bis (first arene) metal complex. In some embodiments, the second arene is chosen based on the first arene of the bis (first arene) metal complex. That is, the second arene may be chosen to have a boiling point that is greater than the first arene of the bis (first arene) metal complex. For example, in some embodiments, a boiling point of the first arene of the bis (first arene) metal complex is less than a boiling point of the second arene. The second arene may be chosen to have a characteristic of being more electron donating than the first arene of the bis (first arene) metal complex. For example, in some embodiments, the first arene of the bis (first arene) metal complex has a fewer number of substituents (and thus may be less electron donating) than the second arene. Accordingly, in some embodiments, the second arene is chosen so as to have a higher boiling point, a greater number of substituents (or otherwise to be more electron donating), or any combination thereof than the first arene of the bis (first arene) metal complex.

In some embodiments, the second arene is an arene of the formula:

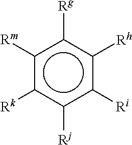

where:
R^{g}, R^{h}, Rⁱ, R^{j}, R^{k}, and R^{m} are each independently a hydrogen, a halogen, a dialkylamino, an alkyl, an alkoxy, an aryl, or a cycloalkyl.

In some embodiments, the second arene is an arene of the formula:

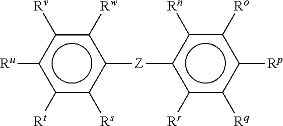

where:
Z is a bond, an alkyl, a heteroatom, or a heteroalkyl; and
Rⁿ, R^{o}, R^{p}, R^{q}, R^{r}, R^{s}, R^{t}, R^{u}, R^{v}, and R^{w} are each independently a hydrogen, a halogen, a dialkylamino, an alkyl, an alkoxy, an aryl, or a cycloalkyl.

In some embodiments, the second arene is a substituted arene, an unsubstituted arene, or any combination thereof. In some embodiments, the second arene is or comprises at least one alkyl-substituted arene. In some embodiments, for example, the second arene comprises at least one of a monoalkylbenzene, a dialkylbenzene, a trialkylbenzene, a tetralkylbenzene, or any combination thereof. In some embodiments, the alkyl comprises or is selected from the group consisting of at least one of a C₁-C₁₀ alkyl, a C₁-C₉ alkyl, a C₁-C₈ alkyl, a C₁-C₇ alkyl, a C₁-C₆ alkyl, a C₁-C₅ alkyl, a C₁-C₄ alkyl, a C₁-C₃ alkyl, a C₂-C₁₀ alkyl, a C₃-C₁₀ alkyl, a C₄-C₁₀ alkyl, a C₅-C₁₀ alkyl, a C₆-C₁₀ alkyl, a C₇-C₁₀ alkyl, a C₈-C₁₀ alkyl, a C₂-C₉ alkyl, a C₂-C₈ alkyl, a C₂-C₇ alkyl, a C₂-C₆ alkyl, a C₂-C₅ alkyl, a C₃-C₅ alkyl, or any combination thereof. In some embodiments, the alkyl comprises or is selected from the group consisting of at least one of methyl, ethyl, n-propyl, 1-methylethyl (iso-propyl), n-butyl, iso-butyl, sec-butyl, n-pentyl, 1,1-dimethylethyl (t-butyl), n-pentyl, iso-pentyl, n-hexyl, isohexyl, 3-methylhexyl, 2-methylhexyl, heptyl, octyl, nonyl, decyl, dodecyl, octadecyl, or any combination thereof.

In some embodiments, for example, the second arene comprises or is selected from the group consisting of at least one of benzene, toluene, o-xylene, m-xylene, p-xylene, o-t-butyltoluene, m-t-butyltoluene, p-t-butyltoluene, 1-ethyl-4-methylbenzene, 1-ethyl-3-methylbenzene, 1-isopropyl-4-methylbenzene, 1-t-butyl-4-methylbenzene, mesitylene, pseudocumene, durene, methylbenzene, dimethylbenzene, trimethylbenzene, ethylbenzene, 1,4-diethylbenzene, triethylbenzene, propylbenzene, butylbenzene, iso-butylbenzene, sec-butylbenzene, t-butylbenzene, hexylbenzene, styrene, naphthalene, anthracene, phenanthrene, biphenyl, terphenyl, methylnaphthalene, biphenylene, dimethylnaphthalene, methylanthracene, 4,4′-dimethylbiphenyl, bibenzyl, diphenylmethane, any isomer thereof, or any combination thereof.

At step 110, in some embodiments, the bis (first arene) metal complex and the second arene are heated to obtain a bis (second arene) metal complex.

The manner in which the bis (first arene) metal complex and the second arene are heated is not particularly limited. In some embodiments, the heating comprises heating the bis (first arene) metal complex and the second arene to a second temperature. In some embodiments, the heating comprises heating the bis (first arene) metal complex and the second arene at a second temperature. In some embodiments, the heating comprises heating the bis (first arene) metal complex and the second arene in an oven, in a furnace, on a hot plate, or other heating device and/or apparatus. In some embodiments, the heating comprises immersing the bis (first arene) metal complex and the second arene in a hot fluid bath (e.g., a hot water bath). In some embodiments, the heating comprises contacting the bis (first arene) metal complex and the second arene with a fluid (e.g., a gas or a vapor, a liquid, etc.) having the second temperature. In some embodiments, the heating comprises exposing the bis (first arene) metal complex and the second arene to a fluid (e.g., a gas or a vapor, a liquid, etc.) having the second temperature.

In some embodiments, the second temperature is a temperature below a decomposition temperature (e.g., a thermal decomposition temperature) of at least one of the bis (first arene) metal complex, the second arene, or any combination thereof. In some embodiments, the second temperature is a temperature at or above a minimum reaction temperature (e.g., for ligand exchange). In some embodiments, the second temperature is a temperature in a range of 100° C. to 200° C. For example, in some embodiments, the second temperature is a temperature in a range 110° C. to 200° C., 115° C. to 200° C., 120° C. to 200° C., 125° C. to 200° C., 130° C. to 200° C., 135° C. to 200° C., 140° C. to 200° C., 145° C. to 200° C., 150° C. to 200° C., 155° C. to 200° C., 160° C. to 200° C., 165° C. to 200° C., 170° C. to 200° C., 175° C. to 200° C., 180° C. to 200° C., 185° C. to 200° C., 190° C. to 200° C., 195° C. to 200° C., or any combination thereof. In some embodiments, the second temperature is a temperature in a range of 100° C. to 195° C., 100° C. to 190° C., 100° C. to 185° C., 100° C. to 180° C., 100° C. to 175° C., 100° C. to 170° C., 100° C. to 165° C., 100° C. to 160° C., 100° C. to 155° C., 100° C. to 150° C., 100° C. to 145° C., 100° C. to 140° C., 100° C. to 135° C., 100° C. to 130° C., 100° C. to 125° C., 100° C. to 120° C., 100° C. to 115° C., 100° C. to 110° C., 100° C. to 105° C., or any combination thereof.

In some embodiments, the heating is performed under a vacuum. In some embodiments, the heating is performed under pressure. For example, the heating may be performed at a pressure in a range of atmospheric pressure to 100 bar. In some embodiments, the pressure is in a range of at least one of 1 bar to 100 bar, 10 bar to 100 bar, 20 bar to 100 bar, 30 bar to 100 bar, 40 bar to 100 bar, 50 bar to 100 bar, 60 bar to 100 bar, 70 bar to 100 bar, 80 bar to 100 bar, 90 bar to 100 bar, 1 bar to 90 bar, 1 bar to 80 bar, 1 bar to 70 bar, 1 bar to 60 bar, 1 bar to 50 bar, 1 bar to 40 bar, 1 bar to 30 bar, 1 bar to 20 bar, 1 bar to 10 bar 1 bar to 5 bar, or any combination thereof.

In some embodiments, the bis (second arene) metal complex is a compound of formula:

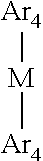

where:
M is a metal; and
Ar₄ is the second arene.

In some embodiments, Ar₄ is an arene of the formula:

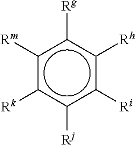

where:
R^{g}, R^{h}, Rⁱ, R^{j}, R^{k}, and R^{m} are each independently a hydrogen, a halogen, a dialkylamino, a hydroxyl, a carbonyl, an alkyl, an alkoxy, an aryl, or a cycloalkyl.

In some embodiments, the bis (second arene) metal complex is a compound of formula:

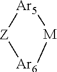

where:
M is a metal;
Ar₅ is an arene;
Ar₆ is an arene; and
Z is a bond, an alkyl, a heteroatom, or a heteroalkyl.

In some embodiments, Ar₅ is an arene of the formula:

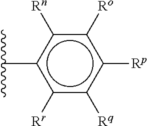

where:
Rⁿ, R^{o}, R^{p}, R^{q}, and R^{r} are each independently a hydrogen, a halogen, a dialkylamino, an alkyl, an alkoxy, an aryl, or a cycloalkyl.

In some embodiments, Ar₆ is an arene of the formula:

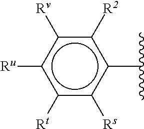

where:
R^{s}, R^{t}, R^{u}, R^{v}, and R^{w} are each independently a hydrogen, a halogen, a dialkylamino, an alkyl, an alkoxy, an aryl, or a cycloalkyl.

In some embodiments, the second arene is a substituted arene, an unsubstituted arene, or any combination thereof. In some embodiments, the second arene is or comprises at least one alkyl-substituted arene. In some embodiments, for example, the second arene comprises at least one of a monoalkylbenzene, a dialkylbenzene, a trialkylbenzene, a tetralkylbenzene, or any combination thereof. In some embodiments, the alkyl comprises or is selected from the group consisting of at least one of a C₁-C₁₀ alkyl, a C₁-C₉ alkyl, a C₁-C₈ alkyl, a C₁-C₇ alkyl, a C₁-C₆ alkyl, a C₁-C₅ alkyl, a C₁-C₄ alkyl, a C₁-C₃ alkyl, a C₂-C₁₀ alkyl, a C₃-C₁₀ alkyl, a C₄-C₁₀ alkyl, a C₅-C₁₀ alkyl, a C₆-C₁₀ alkyl, a C₇-C₁₀ alkyl, a C₈-C₁₀ alkyl, a C₂-C₉ alkyl, a C₂-C₈ alkyl, a C₂-C₇ alkyl, a C₂-C₆ alkyl, a C₂-C₅ alkyl, a C₃-C₅ alkyl, or any combination thereof. In some embodiments, the alkyl comprises or is selected from the group consisting of at least one of methyl, ethyl, n-propyl, 1-methylethyl (iso-propyl), n-butyl, iso-butyl, sec-butyl, n-pentyl, 1,1-dimethylethyl (t-butyl), n-pentyl, iso-pentyl, n-hexyl, isohexyl, 3-methylhexyl, 2-methylhexyl, heptyl, octyl, nonyl, decyl, dodecyl, octadecyl, or any combination thereof.

In some embodiments, for example, the second arene comprises or is selected from the group consisting of at least one of benzene, toluene, o-xylene, m-xylene, p-xylene, o-t-butyltoluene, m-t-butyltoluene, p-t-butyltoluene, 1-ethyl-4-methylbenzene, 1-ethyl-3-methylbenzene, 1-isopropyl-4-methylbenzene, 1-t-butyl-4-methylbenzene, mesitylene, pseudocumene, durene, methylbenzene, dimethylbenzene, trimethylbenzene, ethylbenzene, 1,4-diethylbenzene, triethylbenzene, propylbenzene, butylbenzene, iso-butylbenzene, sec-butylbenzene, t-butylbenzene, hexylbenzene, styrene, naphthalene, anthracene, phenanthrene, biphenyl, terphenyl, methylnaphthalene, biphenylene, dimethylnaphthalene, methylanthracene, 4,4′-dimethylbiphenyl, bibenzyl, diphenylmethane, any isomer thereof, or any combination thereof.

In some embodiments, the metal of the bis (second arene) metal complexes comprises or is selected from the group consisting of a transition metal. In some embodiments, the metal comprises or is selected from the group consisting of a Group VIB metal. In some embodiments, the metal comprises or is selected from the group consisting of at least one of chromium (Cr), molybdenum (Mo), tungsten (W), or any combination thereof. In some embodiments, the metal comprises or is selected from the group consisting of at least one of chromium (Cr), molybdenum (Mo), tungsten (W), iron (Fe), vanadium (V), or any combination thereof.

In some embodiments, the bis (second arene) metal complex is obtained by at least one of filtration, sublimination, distillation, or any combination thereof.

Some embodiments relate to an intermediate precursor. In some embodiments, the intermediate precursor is useful for preparing precursors useful for deposition processes in semiconductor fabrication processes, microelectronic fabrication processes, and the like. The intermediate precursor may be prepared according to the methods disclosed herein. In some embodiments, the intermediate precursor is the bis (first arene) metal complex disclosed herein.

In some embodiments, the intermediate precursor is a compound of formula:

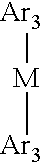

where:
M is a metal; and
Ar₃ is a first arene.

In some embodiments, for example, Ar₃ is an arene of the formula:

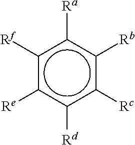

where:
R^{a}, R^{b}, R^{c}, R^{d}, R^{e}, and R^{f} are each independently a hydrogen, a halogen, a dialkylamino, a hydroxyl, a carbonyl, an alkyl, an alkoxy, an aryl, or a cycloalkyl.

In some embodiments, the first arene is a substituted arene, an unsubstituted arene, or any combination thereof. In some embodiments, the first arene is or comprises at least one alkyl-substituted arene. In some embodiments, for example, the first arene comprises at least one of a monoalkylbenzene, a dialkylbenzene, a trialkylbenzene, a tetralkylbenzene, or any combination thereof. In some embodiments, the alkyl comprises or is selected from the group consisting of at least one of a C₁-C₁₀ alkyl, a C₁-C₉ alkyl, a C₁-C₈ alkyl, a C₁-C₇ alkyl, a C₁-C₆ alkyl, a C₁-C₅ alkyl, a C₁-C₄ alkyl, a C₁-C₃ alkyl, a C₂-C₁₀ alkyl, a C₃-C₁₀ alkyl, a C₄-C₁₀ alkyl, a C₅-C₁₀ alkyl, a C₆-C₁₀ alkyl, a C₇-C₁₀ alkyl, a C₈-C₁₀ alkyl, a C₂-C₉ alkyl, a C₂-C₈ alkyl, a C₂-C₇ alkyl, a C₂-C₆ alkyl, a C₂-C₅ alkyl, a C₃-C₅ alkyl, or any combination thereof. In some embodiments, the alkyl comprises or is selected from the group consisting of at least one of methyl, ethyl, n-propyl, 1-methylethyl (iso-propyl), n-butyl, iso-butyl, sec-butyl, n-pentyl, 1,1-dimethylethyl (t-butyl), n-pentyl, iso-pentyl, n-hexyl, isohexyl, 3-methylhexyl, 2-methylhexyl, heptyl, octyl, nonyl, decyl, dodecyl, octadecyl, or any combination thereof.

In some embodiments, for example, the first arene comprises or is selected from the group consisting of at least one of benzene, toluene, o-xylene, m-xylene, p-xylene, o-t-butyltoluene, m-t-butyltoluene, p-t-butyltoluene, 1-ethyl-4-methylbenzene, 1-ethyl-3-methylbenzene, 1-isopropyl-4-methylbenzene, 1-t-butyl-4-methylbenzene, mesitylene, pseudocumene, durene, methylbenzene, dimethylbenzene, trimethylbenzene, ethylbenzene, 1,4-diethylbenzene, triethylbenzene, propylbenzene, butylbenzene, iso-butylbenzene, sec-butylbenzene, t-butylbenzene, hexylbenzene, styrene, naphthalene, anthracene, phenanthrene, biphenyl, terphenyl, methylnaphthalene, biphenylene, dimethylnaphthalene, methylanthracene, 4,4′-dimethylbiphenyl, bibenzyl, diphenylmethane, any isomer thereof, or any combination thereof.

In some embodiments, the metal of the bis (first arene) metal complexes comprises or is selected from the group consisting of a transition metal. In some embodiments, the metal comprises or is selected from the group consisting of a Group VIB metal. In some embodiments, the metal comprises or is selected from the group consisting of at least one of chromium (Cr), molybdenum (Mo), tungsten (W), or any combination thereof. In some embodiments, the metal comprises or is selected from the group consisting of at least one of chromium (Cr), molybdenum (Mo), tungsten (W), iron (Fe), vanadium (V), or any combination thereof.

In some embodiments, the intermediate precursor is a solid. In some embodiments, the intermediate precursor is a liquid.

In some embodiments, the intermediate precursor has a purity of 90% to 100% (i.e., pure). For example, in some embodiments, the precursor has a purity of 91% to 100%, 92% to 100%, 93% to 100%, 94% to 100%, 95% to 100%, 96% to 100%, 97% to 100%, 98% to 100%, 99% to 100%, 99.9% to 100%, 99.99% to 100%, 99.999% to 100%, 99.9999% to 100%, or 99.99999% to 100%.

Some embodiments relate to a precursor. In some embodiments, the precursor is useful for deposition processes in semiconductor fabrication processes, microelectronic fabrication processes, and the like. The precursor may be prepared according to the methods disclosed herein. In some embodiments, the precursor is the bis (second arene) metal complex disclosed herein.

In some embodiments, the precursor is a compound of the formula:

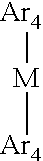

where:
M is a metal; and
Ar₄ is a second arene.

In some embodiments, Ar₄ is an arene of the formula:

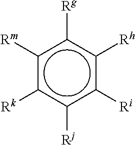

where:
R^{g}, R^{h}, Rⁱ, R^{j}, R^{k}, and R^{m} are each independently a hydrogen, a halogen, a dialkylamino, an alkyl, an alkoxy, an aryl, or a cycloalkyl.

In some embodiments, the precursor is a compound of formula:

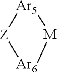

where:
M is a metal;
Ar₅ is an arene;
Ar₆ is an arene; and
Z is a bond, an alkyl, a heteroatom, or a heteroalkyl.

In some embodiments, Ar₅ is an arene of the formula:

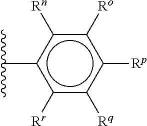

where:
Rⁿ, R^{o}, R^{p}, R^{g}, and R^{r} are each independently a hydrogen, a halogen, a dialkylamino, an alkyl, an alkoxy, an aryl, or a cycloalkyl.

In some embodiments, Ar₆ is an arene of the formula:

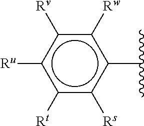

where:
R^{s}, R^{t}, R^{u}, R^{v}, and R^{w} are each independently a hydrogen, a halogen, a dialkylamino, an alkyl, an alkoxy, an aryl, or a cycloalkyl.

In some embodiments, the second arene is a substituted arene, an unsubstituted arene, or any combination thereof. In some embodiments, the second arene is or comprises at least one alkyl-substituted arene. In some embodiments, for example, the second arene comprises at least one of a monoalkylbenzene, a dialkylbenzene, a trialkylbenzene, a tetralkylbenzene, or any combination thereof. In some embodiments, the alkyl comprises or is selected from the group consisting of at least one of a C₁-C₁₀ alkyl, a C₁-C₉ alkyl, a C₁-C₈ alkyl, a C₁-C₇ alkyl, a C₁-C₆ alkyl, a C₁-C₅ alkyl, a C₁-C₄ alkyl, a C₁-C₃ alkyl, a C₂-C₁₀ alkyl, a C₃-C₁₀ alkyl, a C₄-C₁₀ alkyl, a C₅-C₁₀ alkyl, a C₆-C₁₀ alkyl, a C₇-C₁₀ alkyl, a C₈-C₁₀ alkyl, a C₂-C₉ alkyl, a C₂-C₈ alkyl, a C₂-C₇ alkyl, a C₂-C₆ alkyl, a C₂-C₅ alkyl, a C₃-C₅ alkyl, or any combination thereof. In some embodiments, the alkyl comprises or is selected from the group consisting of at least one of methyl, ethyl, n-propyl, 1-methylethyl (iso-propyl), n-butyl, iso-butyl, sec-butyl, n-pentyl, 1,1-dimethylethyl (t-butyl), n-pentyl, iso-pentyl, n-hexyl, isohexyl, 3-methylhexyl, 2-methylhexyl, heptyl, octyl, nonyl, decyl, dodecyl, octadecyl, or any combination thereof.

In some embodiments, for example, the second arene comprises or is selected from the group consisting of at least one of benzene, toluene, o-xylene, m-xylene, p-xylene, o-t-butyltoluene, m-t-butyltoluene, p-t-butyltoluene, 1-ethyl-4-methylbenzene, 1-ethyl-3-methylbenzene, 1-isopropyl-4-methylbenzene, 1-t-butyl-4-methylbenzene, mesitylene, pseudocumene, durene, methylbenzene, dimethylbenzene, trimethylbenzene, ethylbenzene, 1,4-diethylbenzene, triethylbenzene, propylbenzene, butylbenzene, iso-butylbenzene, sec-butylbenzene, t-butylbenzene, hexylbenzene, styrene, naphthalene, anthracene, phenanthrene, biphenyl, terphenyl, methylnaphthalene, biphenylene, dimethylnaphthalene, methylanthracene, 4,4′-dimethylbiphenyl, bibenzyl, diphenylmethane, any isomer thereof, or any combination thereof.

In some embodiments, the metal of the bis (second arene) metal complexes comprises or is selected from the group consisting of a transition metal. In some embodiments, the metal comprises or is selected from the group consisting of a Group VIB metal. In some embodiments, the metal comprises or is selected from the group consisting of at least one of chromium (Cr), molybdenum (Mo), tungsten (W), or any combination thereof. In some embodiments, the metal comprises or is selected from the group consisting of at least one of chromium (Cr), molybdenum (Mo), tungsten (W), iron (Fe), vanadium (V), or any combination thereof.

In some embodiments, the precursor is a solid. In some embodiments, the precursor is a liquid.

In some embodiments, the precursor has a purity of 90% to 100% (i.e., pure). For example, in some embodiments, the precursor has a purity of 91% to 100%, 92% to 100%, 93% to 100%, 94% to 100%, 95% to 100%, 96% to 100%, 97% to 100%, 98% to 100%, 99% to 100%, 99.9% to 100%, 99.99% to 100%, 99.999% to 100%, 99.9999% to 100%, or 99.99999% to 100%.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims provided below.

### Example 1

### Intermediate Precursor—Bis (Benzene) Molybdenum

A mixture comprising benzene ethylbenzene molybdenum, benzene diethylbenzene molybdenum, ethylbenzene diethylbenzene molybdenum (EBDEBMo), bis (ethylbenzene) molybdenum (BEBMo), and bis (diethylbenzene) molybdenum (BDEBMo) was obtained. The mixture was combined with excess benzene (42 mL) in a sealed 350 mL tube with a Teflon screw cap. The tube was degassed and heated to 160° C. for 48 hours. Upon cooling, bis (benzene) molybdenum crystallized and precipitated from solution at about 60% yield. The dark green crystals were isolated by filtration in a glovebox and washed with hexanes. The crystals were subsequently dried under reduced pressure.

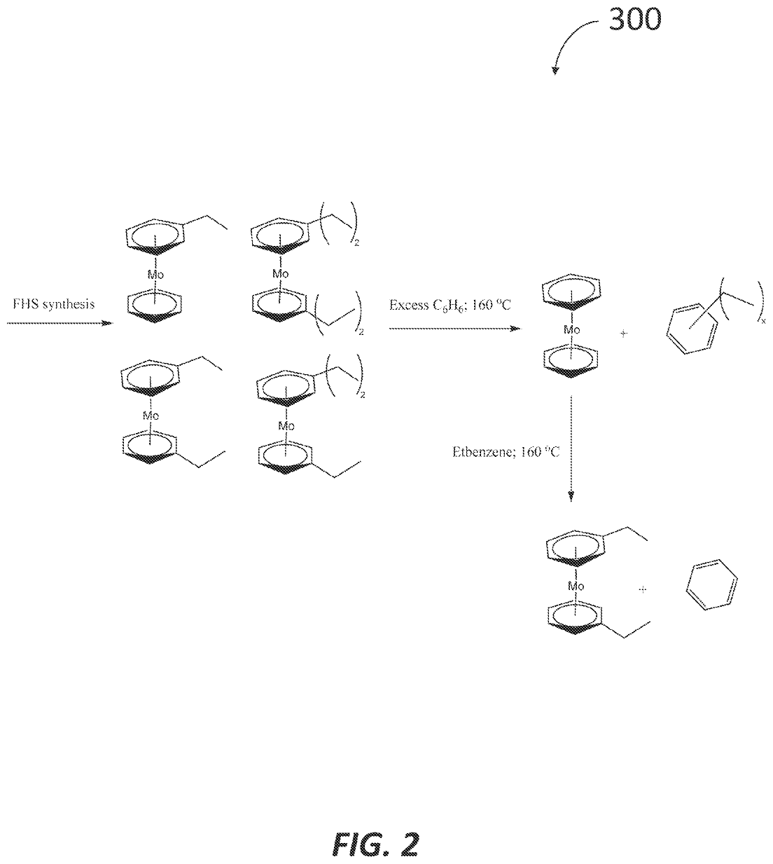

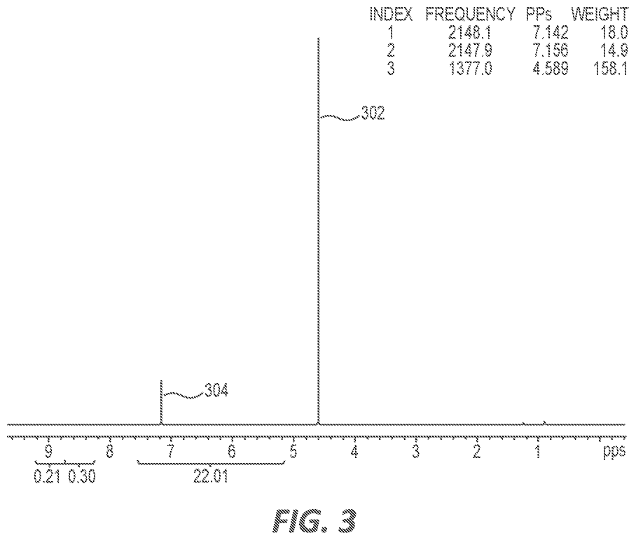

FIG. 2 depicts a non-limiting embodiment of a reaction scheme for preparing a precursor, according to some embodiments. The reaction scheme depicted in FIG. 2 relates to the formation of the intermediate precursor and the precursor. A ¹H NMR spectrum was collected on the crystals in C₆D₆. FIG. 3 is a ¹H NMR spectrum of isolated bis (benzene) molybdenum, according to some embodiments. In FIG. 3, a peak 302 is observed at 4.56 ppm for Mo(C₆H₆)₂ and a peak 304 is observed at 7.16 is observed for residual species (e.g., C₆D₆, C₆D₅H, and the like). The ¹H NMR spectrum confirmed that the crystals were pure and consisted only of bis (benzene) molybdenum complex. The absence of any alkyl substituents (e.g., ethylbenzene isomers) on the benzenes coordinated to molybdenum was confirmed by ¹H NMR spectroscopy.

### Example 2

### Precursor—Bis (Ethylbenzene) Molybdenum

The bis (benzene) molybdenum intermediate precursor obtained from Example 1 is combined with ethylbenzene and heated to a temperature of 160° C. to obtain bis (ethylbenzene) molybdenum. The bis (ethylbenzene) molybdenum is obtained in liquid form as a solution. Excess benzene present in the solution is distilled from the solution to obtain bis (ethylbenzene) molybdenum with a purity of 99% or greater.

### Example 3

### Intermediate Precursor—Bis (Toluene) Molybdenum

A mixture of benzene ethylbenzene molybdenum, benzene diethylbenzene molybdenum, ethylbenzene diethylbenzene molybdenum (EBDEBMo), bis (ethylbenzene) molybdenum (BEBMo), and bis (diethylbenzene) molybdenum (BDEBMo) is obtained. The mixture is combined with excess toluene in a sealed 350 mL tube with a Teflon screw cap. The tube is degassed and heated to 160° C. for 48 hours. Upon cooling, bis (toluene) molybdenum crystallizes and precipitates from solution at about 60% yield. The crystals are isolated by filtration in a glovebox and washed with hexanes. The crystals are subsequently dried under reduced pressure. A ¹H NMR is collected to confirm the crystals are pure bis (toluene) molybdenum and the absence of any arenes other than toluene.

### Example 4

### Precursor—Bis (Ethylbenzene) Molybdenum

The bis (toluene) molybdenum intermediate precursor obtained from Example 3 is combined with ethylbenzene and heated to a temperature of 160° C. to obtain bis (ethylbenzene) molybdenum. The bis (ethylbenzene) molybdenum is obtained in liquid form as a solution. Excess toluene present in the solution is distilled from the solution to obtain bis (ethylbenzene) molybdenum with a purity of 99% or greater.

### Example 5

### Intermediate Precursor—Bis (Xylene) Molybdenum

A mixture of benzene ethylbenzene molybdenum, benzene diethylbenzene molybdenum, ethylbenzene diethylbenzene molybdenum (EBDEBMo), bis (ethylbenzene) molybdenum (BEBMo), and bis (diethylbenzene) molybdenum (BDEBMo) is obtained. The mixture is combined with excess xylene in a sealed 350 mL tube with a Teflon screw cap. The tube is degassed and heated to 160° C. for 48 hours. Upon cooling, bis (xylene) molybdenum crystallizes and precipitates from solution at about 60% yield. The crystals are isolated by filtration in a glovebox and washed with hexanes. The crystals are subsequently dried under reduced pressure. A ¹H NMR is collected to confirm the crystals are pure bis (xylene) molybdenum and the absence of any arenes other than xylene.

### Example 6

### Precursor—Bis (Xylene) Molybdenum

The bis (xylene) molybdenum intermediate precursor obtained from Example 5 is combined with ethylbenzene and heated to a temperature of 160° C. to obtain bis (ethylbenzene) molybdenum. The bis (ethylbenzene) molybdenum is obtained in liquid form as a solution. Excess xylene present in the solution is distilled from the solution to obtain bis (ethylbenzene) molybdenum with a purity of 99% or greater.

### Example 7

### Precursor—Bis (Bibenzyl) Molybdenum

The bis (benzene) molybdenum intermediate precursor obtained from Example 1 is combined with bibenzyl and heated to a temperature of 160° C. to obtain bis (bibenzyl) molybdenum. The bis (bibenzyl) molybdenum is obtained in liquid form as a solution. Excess benzene present in the solution is distilled from the solution to obtain bis (bibenzyl) molybdenum with a purity of 99% or greater. The chemical structure of bis (bibenzyl) molybdenum is presented below:

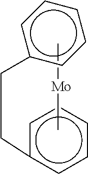

### Example 8

### Precursor—Bis (Diphenylmethane) Molybdenum

The bis (benzene) molybdenum intermediate precursor obtained from Example 1 is combined with diphenylmethane and heated to a temperature of 160° C. to obtain bis (diphenylmethane) molybdenum. The bis (diphenylmethane) molybdenum is obtained in liquid form as a solution. Excess benzene present in the solution is distilled from the solution to obtain bis (diphenylmethane) molybdenum with a purity of 99% or greater. The chemical structure of bis (diphenylmethane) molybdenum is presented below:

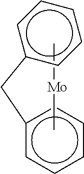

What is claimed is:

1. A method for preparing a precursor, comprising:
combining a mixture of bis (arene) metal complexes and a first arene;
heating the mixture of bis (arene) metal complexes and the first arene; and
cooling the mixture of bis (arene) metal complexes and the first arene to precipitate a bis (first arene) metal complex.

2. The method of claim 1, wherein a boiling point of the arenes of the bis (arene) metal complexes is greater than a boiling point of the first arene.

3. The method of claim 1, wherein each of the bis (arene) metal complexes present in the mixture of bis (arene) metal complexes is independently a bis (arene) metal complex of the formula: 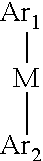
where:
M is a Cr, Mo, W, Fe, or V;
Ar₁ is an arene of the formula: 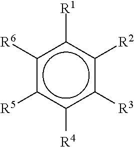
where:
R¹, R², R³, R⁴, R⁵, and R⁶ are each independently a hydrogen, a halogen, a dialkylamino, an alkyl, an alkoxy, an aryl, or a cycloalkyl;
Ar₂ is an arene of the formula: 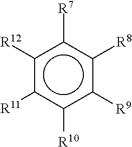
where:
R⁷, R⁸, R⁹, R¹⁰, R¹¹, and R¹² are each independently a hydrogen, a halogen, a dialkylamino, an alkyl, an alkoxy, an aryl, or a cycloalkyl.

4. The method of claim 1, wherein the first arene is an arene of the formula: 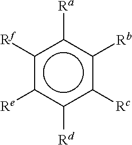
where:
R^{a}, R^{b}, R^{c}, R^{d}, R^{e}, and R^{f} are each independently a hydrogen, a halogen, a dialkylamino, an alkyl, an alkoxy, an aryl, or a cycloalkyl.

5. The method of claim 1, wherein the heating comprises heating to a temperature of 100° C. to 200° C.

6. The method of claim 1, wherein the heating comprises heating at a pressure in a range of atmospheric pressure to 100 bar.

7. The method of claim 1, wherein the cooling comprises exposing to ambient conditions.

8. The method of claim 1, wherein the bis (first arene) metal complex is a complex of the formula: 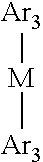
where:
M is Cr, Mo, W, Fe, or V;
Ar₃ is an arene of the formula: 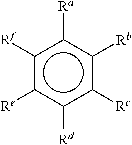
where:
R^{a}, R^{b}, R^{c}, R^{d}, R^{e}, and R^{f} are each independently a hydrogen, a halogen, a dialkylamino, an alkyl, an alkoxy, an aryl, or a cycloalkyl.

9. The method of claim 1, wherein the mixture of bis (arene) metal complexes comprises at least one of benzene ethylbenzene molybdenum, benzene diethylbenzene molybdenum, ethylbenzene diethylbenzene molybdenum (EBDEBMo), bis (ethylbenzene) molybdenum (BEBMo), bis (diethylbenzene) molybdenum (BDEBMo), or any combination thereof.

10. The method of claim 1, wherein the first arene comprises at least one of benzene, toluene, xylene, bibenzyl, diphenylmethane, or any combination thereof.

11. The method of claim 1, wherein the bis (first arene) metal complex is obtained at a yield of 50% or greater.

12. The method of claim 1, further comprising separating the bis (first arene) metal complex by filtration to obtain a purified bis (first arene) metal complex having a purity of 90% or greater.

13. A method for preparing a precursor comprising:
combining a first arene and a mixture of bis (arene) metal complexes;
heating the first arene and the mixture of bis (arene) metal complexes;
cooling the first arene and the mixture of bis (arene) metal complexes to obtain a bis (first arene) metal complex;
combining the bis (first arene) metal complex and a second arene; and
heating the bis (first arene) metal complex and the second arene to obtain a bis (second arene) metal complex.

14. The method of claim 13,
wherein a boiling point of the arenes of the bis (arene) metal complexes is greater than a boiling point of the first arene;
wherein a boiling point of the first arene of the bis (first arene) metal complex is less than a boiling point of the second arene.

15. The method of claim 13, wherein the second arene is an arene having at least one of the following formulas: 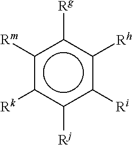
where:
R^{g}, R^{h}, Rⁱ, R^{j}, R^{k}, and R^{m} are each independently a hydrogen, a halogen, a dialkylamino, an alkyl, an alkoxy, an aryl, or a cycloalkyl; or 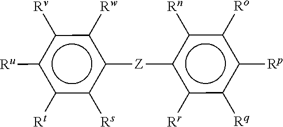
where:
Z is a bond, an alkyl, a heteroatom, or a heteroalkyl; and
Rⁿ, R^{o}, R^{p}, R^{q}, R^{r}, R^{s}, R^{t}, R^{u}, R^{v}, and R^{w} are each independently a hydrogen, a halogen, a dialkylamino, an alkyl, an alkoxy, an aryl, or a cycloalkyl.

16. The method of claim 13, wherein the second arene comprises at least one of benzene, toluene, o-xylene, m-xylene, p-xylene, o-t-butyltoluene, m-t-butyltoluene, p-t-butyltoluene, 1-ethyl-4-methylbenzene, 1-ethyl-3-methylbenzene, 1-isopropyl-4-methylbenzene, 1-t-butyl-4-methylbenzene, mesitylene, pseudocumene, durene, methylbenzene, dimethylbenzene, trimethylbenzene, ethylbenzene, 1,4-diethylbenzene, triethylbenzene, propylbenzene, butylbenzene, iso-butylbenzene, sec-butylbenzene, t-butylbenzene, hexylbenzene, styrene, naphthalene, anthracene, phenanthrene, biphenyl, terphenyl, methylnaphthalene, biphenylene, dimethylnaphthalene, methylanthracene, 4,4′-dimethylbiphenyl, bibenzyl, diphenylmethane, any isomer thereof, or any combination thereof.

17. The method of claim 13, wherein the bis (second arene) metal complex is a complex of at least one of the following formulas: 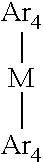
or 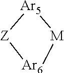
where:
M is Cr, Mo, W, Fe, or V;
Z is a bond, an alkyl, a heteroatom, or a heteroalkyl;
Ar₄ is an arene of the formula: 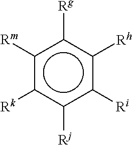
where:
R^{g}, R^{h}, Rⁱ, R^{j}, R^{k}, and R^{m} are each independently a hydrogen, a halogen, a dialkylamino, an alkyl, an alkoxy, an aryl, or a cycloalkyl;
Ar₅ is an arene of the formula: 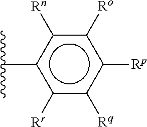
where:
Rⁿ, R^{o}, R^{p}, R^{q}, and R^{r} are each independently a hydrogen, a halogen, a dialkylamino, an alkyl,
an alkoxy, an aryl, or a cycloalkyl;
Ar₆ is an arene of the formula: 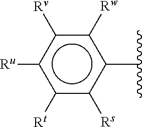
where:
R^{s}, R^{t}, R^{u}, R^{v}, and R^{w} are each independently a hydrogen, a halogen, a dialkylamino, an alkyl, an alkoxy, an aryl, or a cycloalkyl.

18. A precursor comprising a bis (second arene) metal complex according to claim 13, wherein the bis (second arene) metal complex is a liquid having a purity of at least 90%.

19. A composition comprising:
a precursor comprising a bis (arene) metal complex of at least one of the following formulas: 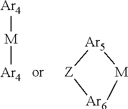
where:
M is Cr, Mo, W, Fe, or V;
Z is a bond, an alkyl, a heteroatom, or a heteroalkyl;
Ar₄ is an arene of the formula: 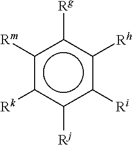
where:
R^{g}, R^{h}, Rⁱ, R^{j}, R^{k}, and R^{m} are each independently a hydrogen, a halogen, a dialkylamino, an alkyl, an alkoxy, an aryl, or a cycloalkyl;
Ar₅ is an arene of the formula: 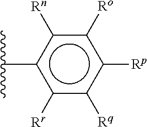
where:
Rⁿ, R^{o}, R^{p}, R^{q}, and R^{r} are each independently a hydrogen, a halogen, a dialkylamino, an alkyl, an alkoxy, an aryl, or a cycloalkyl;
Ar₆ is an arene of the formula: 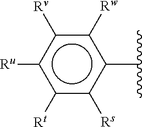
where:
R^{s}, R^{t}, R^{u}, R^{v}, and R^{w} are each independently a hydrogen, a halogen, a dialkylamino, an alkyl, an alkoxy, an aryl, or a cycloalkyl;
wherein the precursor has a purity of 90% or greater.

20. The composition of claim 19, wherein the precursor is a liquid having a purity of 99% or greater.
